(19) United States
(12) Patent Application Publication
(10) Pub. No.: US 2009/0031949 A1
(43) Pub. Date: Feb. 5, 2009

(54) Painting Equipment With Air Purifying Means

(75) Inventors: Bansei Nagase, Saitama (JP); Yoshiyuki Nakazawa, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Minato-ku, Tokyo (JP)

(21) Appl. No.: 11/886,667

(22) PCT Filed: Mar. 24, 2006
(86) PCT No.: PCT/JP2006/306788

§ 371 Date: Oct. 14, 2008

(30) Foreign Application Priority Data
Apr. 5, 2005 (JP) 2005-109057

(51) Int. Cl. B05B 15/12

(52) U.S. Cl. 118/326

(57) ABSTRACT

Water is sprayed from a water nozzle of a water-washing device to wash polluted air in a painting booth, and then, a liquid polymer substance having a character to adsorb a VOC is spayed from an adsorbent spraying nozzle to remove the VOC from the air. A baffle is provided in a discharge duct to prevent the VOC-contained mixed liquid mist from moving with the air. Namely, by causing the air to hit the baffle, the VOC-contained mist turns into drops. Through the water-washing by the water-washing device, VOC adsorption by the mixed liquid and mixed liquid mist removal by the baffle, the polluted air can be sufficiently purified.

### TECHNICAL FIELD

The present invention relates to painting equipment capable of effectively reducing a discharge amount of a volatile organic compound (hereinafter referred to as “VOC”).

### BACKGROUND ART

Generally, painting equipments use a great amount of VOC, such as toluene, for diluting paint. Because the VOC is an air pollutant, it is preferable to minimize the amount of discharge, to the atmosphere, of the VOC.

Heretofore, various techniques have been proposed for reducing the amount of discharge, from a painting booth to the atmosphere, of the VOC (e.g., Japanese Patent Publication No. 3,112,582). Equipment disclosed in the No. 3,112,582 publication includes a means for spraying a great amount of water into a spraying space defined in a floor of a painting booth, and a discharging fan for directing all polluted air within the painting booth to the spraying space so that the polluted air is discharged outside the booth via the spraying space. Namely, the disclosed equipment is characterized by purifying the VOC-contained, polluted air using the water.

However, a study by the inventor of the present invention found that the disclosed equipment could remove very little VOC using the water although it could considerably remove paint residues and dust using the water. Thus, with the disclosed equipment, the VOC would be undesirably discharged to the atmosphere. Thus, there has been a demand for a technique capable of effectively removing the VOC.

### DISCLOSURE OF THE INVENTION

It is therefore an object of the present invention to provide an improved painting equipment which is capable of removing a VOC much more effectively than the conventional water-washing type painting equipment.

In order to accomplish the above-mentioned object, the present invention provides an improved painting equipment, which comprises: a painting booth enclosing an object to be painted and a paint gun, air being blown into the painting booth from above the painting booth to cause paint residues, floating within the painting booth, to descend with the air toward a floor of the painting booth; a water-washing device, provided in the floor of the painting booth, for water-washing the air, the water-washed air being directed from a lower end portion of the painting booth to a discharge duct so that the air is discharged outside the painting booth through the discharge duct; an adsorbent spraying nozzle, provided in the discharge duct, for spraying a mixed fluid to the water-washed air, the mixed fluid being a mixture of water and liquid polymer substance having a character to adsorb a volatile organic solvent; and a spray control section for controlling spraying operation timing of the adsorbent spraying nozzle.

In the painting equipment of the present invention arranged in the above-described manner, the water-washed air is sent from the lower end portion of the painting booth to the discharge duct, where the adsorbent spraying nozzle sprays the mixed liquid of water and liquid polymer substance to the water-washed air so that the air can be further cleaned by the liquid polymer substance adsorbing the volatile organic solvent (or VOC) mixed in the air. As a result, the VOC in the air can be removed with a greatly enhanced efficiency. Further, by the provision of the spray control section, the liquid polymer substance can be caused to act on the water-washed air only when necessary. Thus, the present invention can prevent unnecessary spraying of the liquid polymer substance, to thereby effectively save the cost for procuring the liquid polymer substance and energy necessary for spraying the liquid polymer substance.

Further, where a time required for a residue of paint, emitted by the paint gun, to reach the adsorbent spraying nozzle along with the air is assumed to be a predetermined time, the spray control section controls the adsorbent spraying nozzle to start spraying the mixed liquid upon lapse of the predetermined time from a time point when a signal for instructing the paint gun to start painting is generated and to stop spraying the mixed liquid upon lapse of the pre-determined time from a time point when a signal for instructing the paint gun to stop painting is given. With such arrangements, the present invention can reliably prevent the unnecessary spraying of the liquid polymer substance, so that the cost for procuring the liquid polymer substance and energy necessary for spraying the liquid polymer substance can be saved with an even further enhanced reliability.

In a preferred embodiment, a plurality of the adsorbent spraying nozzles are provided in spaced-apart relation to each other along a path of air flow in the discharge duct, so as to achieve even further purification of the air.

In a preferred embodiment, the painting equipment further comprises a baffle provided in the discharge duct and inclined at an angle of 20-70 degrees with respect to a horizontal line so that mist of the mixed liquid contained in the air, sent from the lower end portion of the painting booth, is turned into a drop by hitting the baffle and then, in the drop form, directed via the baffle toward a predetermined liquid outlet of the painting booth.

Because the liquid polymer substance, having adsorbed the organic solvent or VOC, enters the discharge duct in minute mist form, there is a possibility of a portion of the liquid polymer substance with the VOC being discharged to the atmosphere together with the air. This is why the baffle is provided in the discharge duct in the equipment of the invention. The mist of the liquid polymer substance and VOC is turned into a drop or drops after hitting and adhering to the surface of the baffle, and such drops are withdrawn together with the water. As a result, the present invention can greatly reduce the amount of the VOC discharged to the atmosphere.

If the baffle is provided at an inclination angle less than 20 degrees with respect to the horizontal line, the drops can not easily fall down the surface of the baffle, so that they might again get mixed into the air. If, on the other hand, the baffle is provided at an inclination angle more than 70 degrees with respect to the horizontal line, the mist can efficiently hit the baffle, but a flow path resistance would increase, which undesirably results in a reduced flow rate in the discharge duct.

### BRIEF DESCRIPTION OF DRAWINGS

a. A preferred embodiment of the present invention will be described in detail below, by way of example only, with reference to the accompanying drawings, in which:

FIG. 1 is a view explanatory of the basic principles of a painting equipment in accordance with the present invention;

FIG. 2 is a sectional view showing relevant sections of a discharge duct employed in the present invention;

FIG. 3 is an enlarged view of one of a plurality of adsorbent spraying nozzles employed in the present invention;

FIG. 4 is a diagram explanatory of a spray control section employed in the present invention; and

FIGS. 5A and 5B are views schematically showing a liquid polymer substance employed in the present invention

### BEST MODE FOR CARRYING OUT THE INVENTION

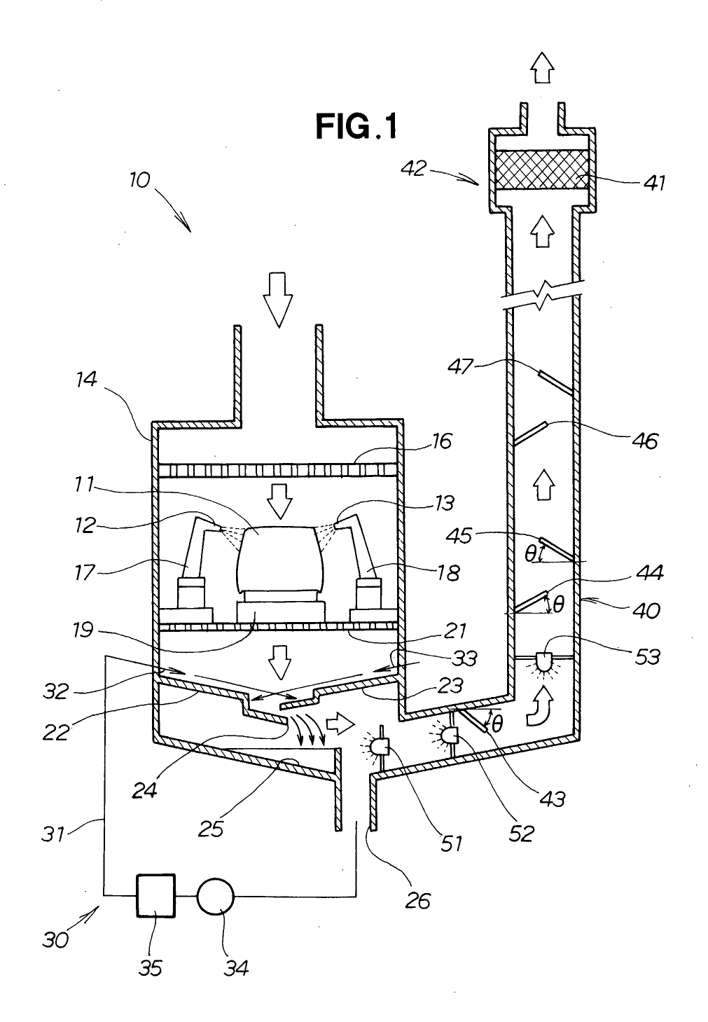

FIG. 1 is a view explanatory of the basic principles of a painting equipment in accordance with the present invention. This painting equipment 10 includes a tunnel-shaped painting booth 14 enclosing an object to be painted (e.g., vehicle body) 11 and paint guns 12 and 13 that spray paint mist. Air is blown into the painting booth 14 from above the painting booth 14, to cause paint residues, floating within the painting booth 14, to descend along with the blown air. The painting equipment 10 also includes a water-washing device 30, provided in a lower end portion of the painting booth 14 air, for washing the blown air. The thus water-washed air is directed from the lower end portion of the painting booth 14 to a discharge duct 40, through which the water-washed air is discharged out of the painting equipment 10 through a silencer 42 having a built-in filter 41. The painting equipment 10 further includes, in the duct 40, adsorbent spraying nozzles 51-53 for spraying a mixed liquid that is a mixture of water and liquid polymer substance having a character to adsorb a volatile organic solvent (VOC), and baffles 43-47.

Reference numeral 16 indicates a flow adjustment plate for adjusting air flows, 17 and 18 robots for handling the paint guns 12 and 13, 19 a conveyor, 21 a porous floor, 22 and 23 slanted floors, 24 an exit, 25 a water storage section, and 26 a predetermined liquid outlet.

The water-washing device 30 includes a conduit 31, water nozzles 32 and 33, a pump 34, a separator 35, etc. The water nozzles 32 and 33 spray high-pressure water onto the slanted floors 22 and 23 to thereby produce strong swirling currents in the neighborhood of the exit 24, so that the polluted air can be cleaned by being drawn into the swirling currents. Paint residues and dust are deposited in the water storage section 25, and only a clear upper portion of the water returns from the water storage section 25, via the liquid outlet 26, to the conduit 36.

The separator 35 is a device for removing foreign matters and impurities from water, by centrifugal separation, density separation, chemical separation or other suitable separation method.

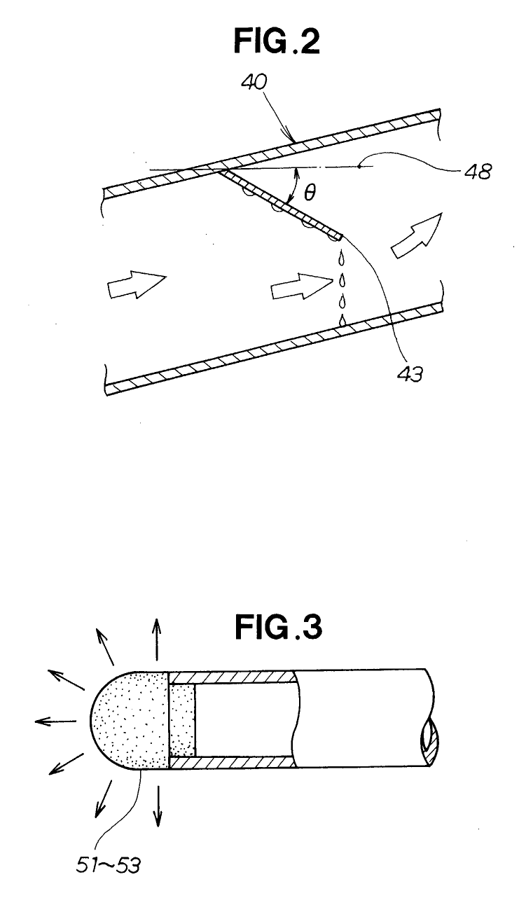

FIG. 2 is a sectional view showing relevant sections of the discharge duct 40 employed in the present invention, which representatively shows one of the baffles 43 provided in the discharge duct 40. The baffle 43 is inclined downward or upward at an angle θ with respect to a horizontal line 48, to thereby promote falling of drops of the mixed liquid mist, as will be later detailed.

If the baffle 43 is inclined at an angle less than 20 degrees with respect to the horizontal line 48, it is difficult for the drops to fall from the baffles 43. If the baffle 43 is inclined at an angle more than 70 degrees with respect to the horizontal line 48, then the mixed liquid mist can efficiently hit the baffle 43; however, a flow path resistance would increase, which results in a reduced flow rate of the air in the discharge duct 40.

The same explanation applies to the other baffles 44-47. Note that the number of the baffles 43-47 is not limited to five and may be four or less or six or more.

FIG. 3 is an enlarged view of one of the adsorbent spraying nozzles 51-53 employed in the present invention. As shown in FIG. 1, the adsorbent spraying nozzles 51-53, provided in spaced-apart relation to one another along an air flow path, are positioned so as to be opposed to the polluted air. It is preferable that each of the adsorbent spraying nozzles 51-53 be formed of a porous substance into a semispherical shape. The semispherical shape can provide a spread angle of 180 degrees, and the porous substance can produce very fine water jets.

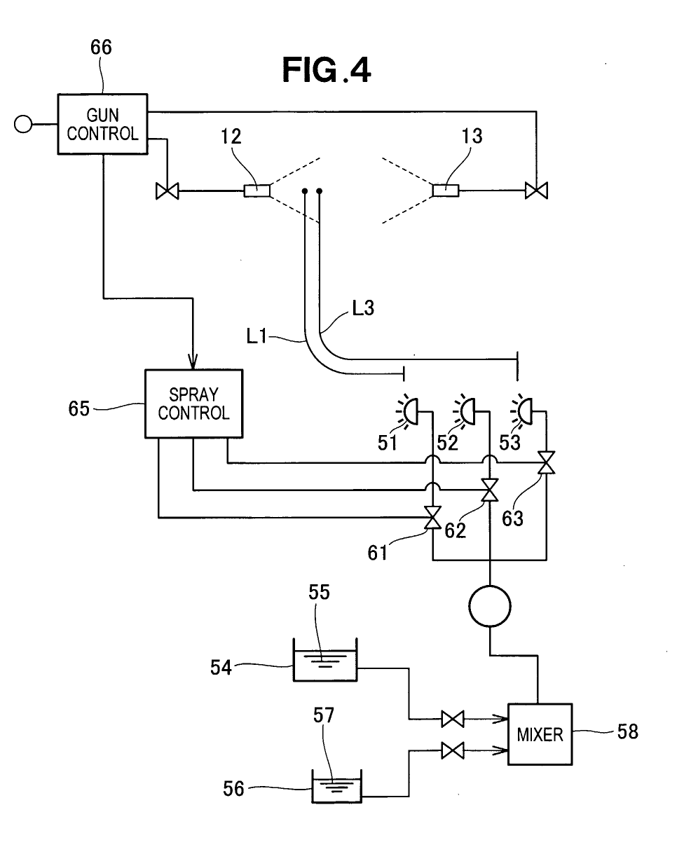

FIG. 4 is a diagram explanatory of a spray control section 65 employed in the present invention. Water stored in a water tank 54 and liquid polymer substance 57 stored in a liquid polymer tank 56 are mixed together, via a mixer 58, at a predetermined mixture ratio, and the thus-obtained mixture is supplied to the adsorbent spraying nozzles 51-53 via corresponding valves 61-63 so that the mixture is sprayed in mist form through the nozzles 51-53. Opening/closing of the valves 61-63 is controlled by the spray control section 65.

The spray control section 65 is given painting/non-painting information (e.g., a signal instructing the paint guns to start painting and a signal instructing the paint guns to start painting) from a paint gun control section 66 that controls the paint guns 12 and 13, and it performs opening/closing control on the valves 61-63 on the basis of the given painting/non-painting information. The opening/closing control may be performed in any one of the following two control patterns.

According to the first control pattern, once the signal instructing the paint guns to start painting is given from the paint gun control section 66, the spray control section 65 opens the valves 61-63 to start spraying of the mixed liquid. Then, once the signal instructing the paint guns to stop painting is given from the paint gun control section 66, the spray control section 65 closes the valves 61-63 to stop the spraying of the mixed liquid.

According to the second control pattern, once the signal instructing the paint guns to start painting is given from the paint gun control section 66, the spray control section 65 activates a timer to start counting time. When the timer has counted a predetermined time T1, i.e. upon lapse of the pre-determined time T1, from the time point when the signal instructing the paint guns to start painting was given, the spray control section 65 opens the valves 61-63 to start spraying of the mixed liquid. Then, once the signal instructing the paint guns to stop painting is given from the paint gun control section 66, the spray control section 65 activates the timer, and, upon lapse of the predetermined time T2 from the time point when the signal instructing the paint guns to stop painting was given, the spray control section 65 closes the valves 61-63 to stop the spraying of the mixed liquid.

The flow rate of the air flowing in the painting booth 14 and discharge duct 40 is previously known, and a distance L1 from the paint guns 12 and 13 to the first adsorbent spraying nozzle 51 closest to the guns 12 and 13 is fixed. The above-mentioned predetermined time T1 is equal to or slightly shorter than a time required for the air to flow the distance T1. The above-mentioned predetermined time T2 is equal to or slightly longer than a time required for the air to flow a distance L3 from the paint guns 12 and 13 to the last adsorbent spraying nozzle 53 remotest from the paint guns 12 and 13.

Thus, the mixed fluid can be sprayed only to the air containing paint residues, and the mixed fluid can be prevented from being sprayed to the air containing no paint residue. As a consequence, it is possible to avoid the expensive liquid polymer substance from being wasted.

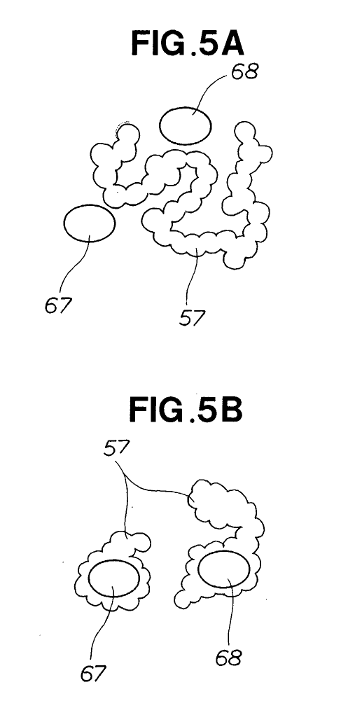

FIGS. 5A and 5B are views schematically showing the liquid polymer substance employed in the present invention.

The liquid polymer substance 57 is preferably “microgel” commercially available from Kalmor (i.e., Karumoa Co. LTD). This liquid polymer substance 57 is a sort of ameboid substance. More specifically, the liquid polymer substance 57 is gel that has both of positive and negative polarities and has a total molecular weight of tens of millions. Namely, the molecular weight of the liquid polymer substance 57 is about one million times greater than water and about two hundred thousand times greater than toluene.

As VOC particles 67 and 68 approach the liquid polymer substance 57, the liquid polymer substance 57 first electrically adsorb the particles 67 and 68, as seen in FIG. 5A. Then, the liquid polymer substance 57 embraces the VOC particles 67 and 68. In this way, the liquid polymer substance 57 separates the VOC particles 67 and 68 from the air.

Namely, if the molecular weight of water is represented by a value “1”, then the molecular weight of toluene is “5” that is greater than molecular weight of water, and thus, the VOC particles 67 and 68, which are toluene particles in the illustrated example, can not be embraced by water. Further, if the molecular weight of toluene is represented by a value “1”, then the molecular weight of the liquid polymer substance 57 employed in the present invention amounts to “20×10⁴”, and thus, the toluene particles etc. can be effectively embraced by the powerful liquid polymer substance 57.

Referring back to FIG. 1, a portion of the paint mist sprayed from the paint guns 12 and 13 floats in the air without adhering to the object to be painted 11, and the VOC evaporated from the sprayed paint mist gets mixed into the air. The air thus polluted with the VOC passes through the porous floor 21 to flow downward and is then washed with water swirling in the neighborhood of the exit 24. The water-washing can sufficiently remove paint residues and dust from the air, at which time VOC particles adhered to the paint residues and dust can also be removed by the water-washing.

VOC particles, which have not been successfully removed (i.e., which have slipped through the water-washing, enter the discharge duct 40 together with the air. In the discharge duct 40, the mixed liquid is sprayed, by the first adsorbent spraying nozzle 51, to the polluted air, and then a portion of the VOC, together with the mixed liquid, falls toward the bottom of the discharge duct 40 to ultimately reach the liquid outlet 26. Remaining portion of the VOC can be removed by means of the succeeding adsorbent spraying nozzles 52 and 53.

However, because the mixed liquid having adsorbed the VOC is also in the form of minute mist, there is a possibility of a portion of the mixed liquid moving together with the air. Therefore, in the present invention, the baffles 43-47 are provided, and the air with the mixed liquid mist is caused to hit the baffles 43-47 so that the mist is turned into liquid drops. Then, the drops of the mixed liquid are directed along the slanted surfaces of the baffles 43-47 to the inner surface of the discharge duct 40. Consequently, the drops flow down the duct inner surface to the liquid outlet 26 and fall outside the booth 14 through the liquid outlet 26.

By virtue of the above-described water-washing by the water-washing device 30, mixed liquid spraying by the adsorbent spraying nozzles 51-53 and mixed liquid removal by the baffles 43-47, the painting equipment of the present invention can effectively purify the polluted air into sufficiently clean air before discharging the air to the atmosphere.

### INDUSTRIAL APPLICABILITY

The painting equipment of the present invention is particularly suited for use with vehicle-body painting booths.

1. Painting equipment comprising:
a painting booth for enclosing an object to be painted and a paint gun, said painting booth being adapted to have air blown therein from above said painting booth to cause paint residues, floating within said painting booth, to descend with the air toward a floor of said painting booth;
a water-washing device, provided in the floor of said painting booth, for water-washing the air, the water-washed air being directed to flow from a lower end portion of said painting booth to a discharge duct so that the air is discharged outside said painting booth through the discharge duct;
an adsorbent spraying nozzle, provided in the discharged duct, for spraying a mixed liquid to the water-washed air, the mixed liquid including a mixture of water and liquid polymer substance having a character to adsorb a volatile organic solvent; and
a spray control section for controlling spraying operation timing of said adsorbent spraying nozzle.

2. The painting equipment according to claim 1, wherein, where a time required for a residue of paint, emitted by the paint gun, to reach said adsorbent spraying nozzle along with the air is assumed to be a predetermined time, said spray control section controls said adsorbent spraying nozzle to start spraying the mixed liquid upon lapse of the predetermined time from a time point when a signal for instructing the paint gun to start painting is generated and to stop spraying the mixed liquid upon lapse of the predetermined time from a time point when a signal for instructing the paint gun to stop painting is given.

3. The painting equipment according to claim 1, wherein a plurality of the adsorbent spraying nozzles are provided in spaced-apart relation to each other along a path of air flow in the discharge duct.

4. The painting equipment according to claim 1, further comprising a baffle provided in the discharge duct at an inclination angle of 20-70 degrees with respect to a horizontal line, so that mist of the mixed liquid contained in the air, sent from the lower end portion of said painting booth, is turned into a drop by hitting said baffle and then, in the drop form, directed via said baffle toward a predetermined liquid outlet of said painting booth.

5. The painting equipment according to claim 4, wherein a plurality of the baffles are provided in spaced-apart relation to each other along a path of air flow in the discharge duct.

6. The painting equipment according to claim 1, wherein the discharge duct extends outwardly and upwardly of said painting booth.

7. The painting equipment according to claim 1, wherein the painting booth includes a liquid outlet beneath said floor, and the water washing device includes a mechanism for cleaning and reusing water discharged through said liquid outlet.

8. The painting equipment according to claim 1, wherein the liquid polymer substance is a microgel.
